(19) United States
(12) Patent Application Publication
(10) Pub. No.: US 2013/0002072 A1
(43) Pub. Date: Jan. 3, 2013

(54) ELECTRIC MOTOR WITH INTEGRAL REDUCTION GEAR SET

(75) Inventor: Andrew W. Phillips, Rochester, MI (US)

(73) Assignee: GM GLOBAL TECHNOLOGY OPERATIONS LLC, Detroit, MI (US)

(21) Appl. No.: 13/173,063

(22) Filed: Jun. 30, 2011

(51) Int. Cl. H02K 7/116; H02K 15/00

(52) U.S. Cl. 310/83; 29/596

(57) ABSTRACT

A vehicle includes a transmission having an input member on a primary axis and a motor positioned on the primary or a secondary axis. The motor includes a rotor circumscribing a rotor shaft connected to the input member, a stator having axially-extending end-windings, and a reduction gear set. The gear set is positioned substantially within in a void or radial space between the end windings. The gear set may include a first member on the rotor shaft and a stationary second member positioned adjacent to the end windings. A method for assembling the motor includes providing the gear set, stator, and rotor, connecting the ring gear to the stationary member, and inserting the carrier member into the ring gear from an axial side of the traction motor until the gear set is substantially inside of the void between the end windings.

### TECHNICAL FIELD

The present disclosure relates to an electric traction motor of the type used in a hybrid vehicle powertrain.

### BACKGROUND

Sales of vehicles having electric drive capabilities have continued to grow as consumers respond to rising fuel prices and environmental concerns. Hybrids use a unique powertrain configuration to optimize fuel economy relative to vehicles relying exclusively on an internal combustion engine as a power source. Conventional hybrid powertrains typically use a high-voltage electric traction motor alone in an electric vehicle or EV mode, or in conjunction with the engine in various electric assist modes. Hybrid motors must be properly sized and placed within the powertrain to deliver sufficient levels of motor torque to the vehicle transmission. The size, weight, and required support structure of a typical hybrid motor is a design concern, one that cannot always be rectified solely via off-axis placement of the hybrid motor.

### SUMMARY

An electric traction motor is disclosed herein which may be used to power a vehicle having a hybrid powertrain. A hybrid motor is typically situated on the transmission end of a primary axis, and therefore competes for packaging space with various transmission components. In turn, the reduced packaging space can require a relatively expensive and heavy motor/rotor hub for support, in addition to the typically large volumes of copper or steel used in the hybrid motors used on the road today. These important design concerns can be alleviated in some vehicles using the present motor design and assembly approach.

In particular, a vehicle is disclosed having a transmission and an electric traction motor. The transmission includes an input member on a primary axis of the vehicle, and the electric traction motor is positioned on the primary axis or on a secondary axis. The motor includes a rotor circumscribing a rotor shaft connected to the input member, and a stator positioned radially-outward of the rotor. The stator has axially-extending end windings defining a void or radial space therebetween. The motor also includes a reduction gear set positioned substantially within the void or radial space existing between the end windings.

The motor noted above is also disclosed herein, along with a method for assembling the same. The method includes providing the reduction gear set, a stator with axially-extending end-windings, and a rotor, with the rotor circumscribing a rotor shaft to which the sun gear is connected or integrally formed. The method also includes connecting the ring gear to a stationary member such that the ring gear cannot rotate, and then inserting the carrier member into the ring gear from an axial side of the traction motor until the reduction gear set is positioned substantially inside of a radial space or void between the end windings.

The above features and advantages and other features and advantages of the present invention are readily apparent from the following detailed description of the best modes for carrying out the invention when taken in connection with the accompanying drawings.

### BRIEF DESCRIPTION OF THE DRAWINGS

FIG. 1 is a schematic illustration of a vehicle having an electric traction motor with an integral reducing gear set configured and positioned as set forth herein.

FIG. 2 is a schematic cross-sectional illustration of the motor and gear set shown in FIG. 1.

FIG. 3 is a flow chart describing an example method for assembling the motor and gear set of FIG. 2.

### DESCRIPTION

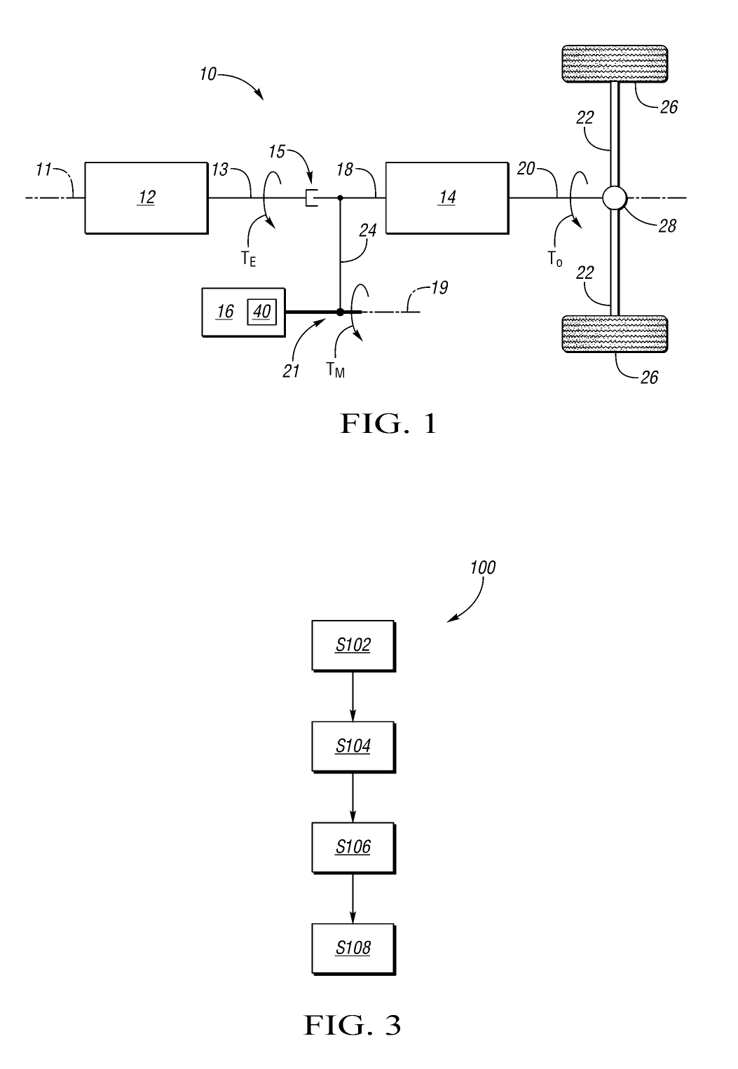

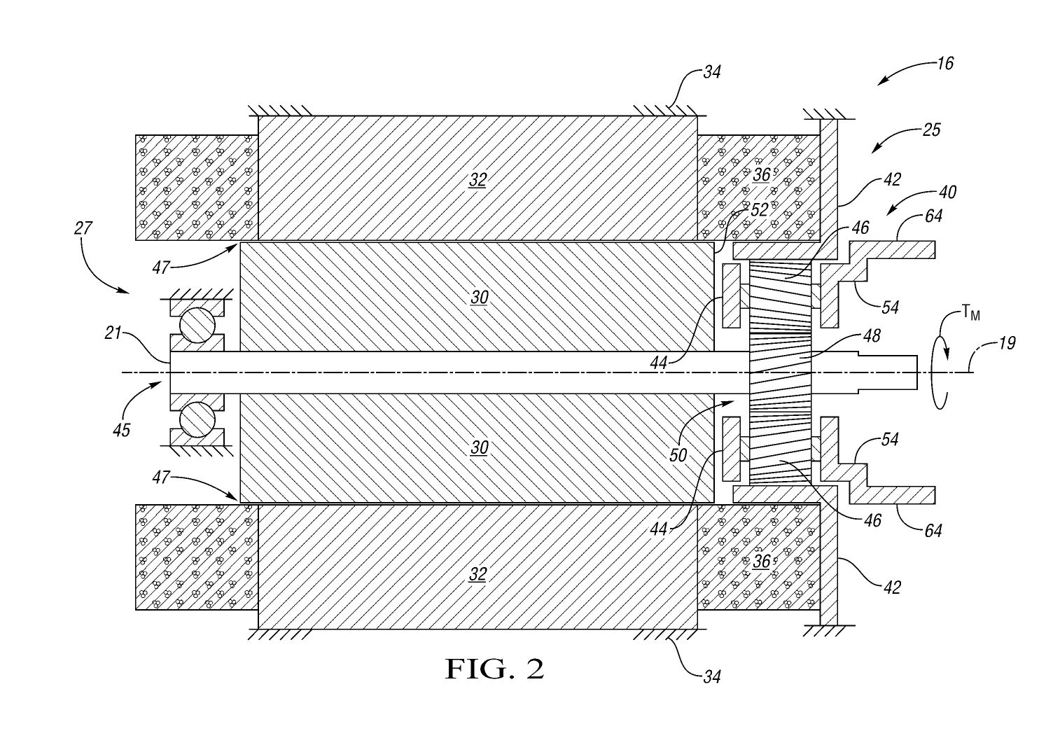

Referring to the drawings, wherein like reference numbers correspond to like or similar components throughout the several figures, a vehicle 10 is shown schematically in FIG. 1. The vehicle 10 is configured with a hybrid electric powertrain, and therefore includes an internal combustion engine 12 and an electric traction motor 16. As described below, a reduction gear set 40 is used within the envelope of the motor 16, i.e., positioned substantially or fully within a radial space or void 50 existing between the end windings 36 (see FIG. 2) of the motor 16.

Depending on the operating mode, the engine 12 and/or the motor 16 may provide a respective engine torque (arrow T_{E}) and motor torque (arrow T_{M}) as input torque to an input member 18 of a transmission 14. An output output member 20 of the transmission 14 delivers a transmission output torque (arrow T_{O}) to one or more axles 22, and ultimately to a set of drive wheels 26, e.g., via a differential 28 as shown.

The engine 12 and the transmission 14 are positioned along a primary axis 11 of the vehicle 10. The motor 16 is shown positioned on a secondary axis 19 that is different from the primary axis 11, i.e., the motor 16 is “off-axis”, as that term is well known in the art. Although an off-axis configuration is shown in the example embodiment of FIG. 1, the motor 16 may be positioned on the primary axis 11 in an alternative embodiment without departing from the intended inventive scope.

An input clutch 15 may be selectively disengaged to disconnect a driveshaft 13 of the engine 12 from the input member 18 of the transmission 14, for instance during electric vehicle (EV) operating modes. The motor 16 is connected to the input member 18 of the transmission 14 via a transfer mechanism 24, e.g., a chain or gear drive mechanism. The motor 16 generates motor torque (arrow T_{M}) on a rotor shaft 21. The motor torque (arrow T_{M}) in this particular embodiment is transferred to the primary axis 11 via the drive mechanism 24.

Referring to FIG. 2, the present traction motor 16 may be embodied as a poly-phase induction motor which includes a stator 32 and a solid-iron/ferrous rotor 30. The stator 32 and rotor 30 mutually define a minimal air gap (arrow 47). The rotor 30 is connected to a rotor shaft 21, which in keeping with the example embodiment of FIG. 1 is shown oriented along the secondary axis 19.

The stator 32 is connected to a stationary member 34, and includes a set of induction coils in the form of axially-extending end windings 36. Although not shown in FIG. 2 for simplicity, those of ordinary skill in the art will appreciate that the end windings 36 may be selectively energized by a battery as needed to generate an electromagnetic field with respect to the stator 32. The generated field is opposed by a field emanating from the solid-iron rotor 30, thus causing the rotor shaft 21 to rotate.

A void 50 is defined in the radial space between the end windings 36 at a first axial end 25 of the traction motor 16. The reduction gear set 40 noted above is positioned substantially or fully within the void 50. The motor 16 is further characterized by an absence of a bearing between the rotor 30 and the reduction gear set 40. That is, the gear set 40 is immediately adjacent to the rotor 30, with no intervening structure between the gear set 40 and rotor 30. At a second axial end 27 of the motor 16, i.e., the opposite end to the first axial end 25, a bearing assembly 45 may be used to support the rotor shaft 21. A similar bearing assembly (not shown) may also be used axially-outward of the motor 16, i.e., outside of the envelope of the motor 16, to support the weight of the motor 16 from the second axial end 27 as needed.

In a particular non-limiting embodiment, the reduction gear set 40 is a planetary gear set having a plurality of elements. The elements may include a ring gear 42, which is locked or grounded with respect to the stationary member 34. The reduction gear set 40 includes a carrier member 44 with pinion gears 46, as well as a sun gear 48. The sun gear 48 may be formed integrally with the rotor shaft 21 or connected thereto so that the sun gear 48 rotates in conjunction with the rotor shaft 21.

The ring gear 42 may be positioned immediately adjacent to the end windings 36, i.e., axially and radially adjacent as shown. Although splines are omitted from the schematic FIG. 2 for illustrative simplicity, one of ordinary skill in the art will appreciate that mating teeth or splines are typically used between engaging elements of a planetary gear set such as the present reduction gear set 40, and therefore may exist between the ring gear 42 and pinion gears 46, and between the pinion gears 46 and the sun gear 48.

An axial extension 54 of the carrier member 44 may be used as a platform for splining or otherwise connecting a power take-off mechanism 64 suitable for engaging the transfer mechanism 24 shown in FIG. 1, e.g., a chain and a pair of sprockets, a consecutively-engaged sequence of two or more external gears, etc. Other embodiments may exist which position different members of the reduction gear set 40 in the indicated locations, provided the reduction gear set 40 remains positioned as shown substantially or fully within the void 50 and adjacent to an axial surface 52 of the rotor 30.

In a non-limiting example embodiment, the traction motor 16 of FIG. 2 may be rated for approximately 50-Nm to approximately 75-Nm, and may rotate at approximately 26,000 RPM. The reduction gear set 40 may be configured as a 3:1 ring/sun (RS) planetary gear set providing 4:1 speed reduction, which operates through a 1.5:1 silent chain to produce the desired speed and torque at the primary axis 11 in an off-axis embodiment. Other embodiments may be readily envisioned without departing from the intended inventive scope.

Referring to FIG. 3, a method 100 is shown for assembling the fraction motor 16 of FIG. 2. The method 100 begins with step S102, wherein the stator 32 and the rotor 30 are provided, e.g., a solid-iron or solid-ferrous rotor in one possible embodiment. Step S102 may entail providing the rotor shaft 21 with an integrally-formed sun gear 48 or otherwise attaching the sun gear 48 to the rotor shaft 21.

At step S104, the ring gear 42 is connected to the stationary member 34 as shown in FIG. 2. Step S104 may entail placing the ring gear 42 radially- and axially-adjacent to the end windings 36, and then splining or otherwise connecting the ring gear 42 to the stationary member 34 such that the ring gear is fully grounded and cannot rotate.

At step S106, the carrier member 44 and the pinion gears 46 of FIG. 2 are inserted into the ring gear 42 from the first axial end 25 of the traction motor 16. Step S106 may entail engaging teeth of the pinion gears 46 with mating teeth of the ring gear 42, which once again are omitted from FIG. 2 for illustrative simplicity. The present method 100 is finished once the reduction gear set 40 is positioned substantially inside of the radial space or void (arrow 50) existing between the end windings 36. The motor 16 can then be connected to the input member 18 of the vehicle 10 shown in FIG. 1. Alternatively, the method 100 continues with step S108 when the motor 16 is configured as an off-axis motor as shown in the example embodiment of FIG. 1.

In optional step S108, when the traction motor 16 is positioned on the secondary axis 19 as shown in FIG. 1, the reduction gear set 40 is connected to the primary axis 11 of FIG. 1 via the axial extension 54 of the carrier 44. Step S108 may entail connecting a chain and a pair of sprockets or a consecutively-engaged sequence of two or more external gears, or any other power transfer mechanism, to transfer motor torque (T_{M}) as shown in FIG. 1 from the secondary axis 19 to the primary axis 11.

While the best modes for carrying out the invention have been described in detail, those familiar with the art to which this invention relates will recognize various alternative designs and embodiments for practicing the invention within the scope of the appended claims.

1. A vehicle comprising:
a transmission having an input member on a primary axis; and
an electric traction motor positioned on one of the primary axis and a secondary axis, wherein the electric traction motor includes:
a rotor circumscribing a rotor shaft connected to the input member;
a stator positioned radially-outward of the rotor and having axially-extending end windings; and
a reduction gear set positioned substantially within a void or radial space defined between the end windings.

2. The vehicle of claim 1, wherein the reduction gear set is a planetary gear set having a first member that is connected to or formed integrally with the rotor shaft, and a stationary second member which is positioned immediately adjacent to the end windings.

3. The vehicle of claim 2, further comprising a power take-off mechanism, wherein the planetary gear set includes a third member having an axial extension in driving connection with the power take-off mechanism.

4. The vehicle of claim 3, wherein the motor is positioned on the secondary axis, and wherein the power take-off mechanism is connected to the input member of the transmission and the primary axis via one of: a chain and a pair of sprockets, and a consecutively-engaged sequence of two or more external gears.

5. The vehicle of claim 2, wherein:
the first member is a sun gear;
the reduction gear set further includes a third member configured as a carrier member with a plurality of pinion gears which mesh with the sun gear; and
the second member is a stationary ring gear which circumscribes the pinion gears and the sun gear.

6. The vehicle of claim 1, wherein the motor is characterized by an absence of a support bearing between the rotor and the reduction gear set.

7. An electric traction motor comprising:
a rotor circumscribing a rotor shaft, wherein the shaft is configured for connection to an input member of a transmission;
a stator positioned radially-outward of the rotor, and having axially-extending end windings defining a void or radial space with respect to each other; and
a reduction gearset positioned substantially within the void or radial space existing between the end windings.

8. The electric traction motor of claim 7, wherein the reduction gear set is a planetary gear set having a first member that is connected to or formed integrally with the rotor shaft, and a stationary second member which is positioned immediately adjacent to the end windings.

9. The electric traction motor of claim 8, further comprising a power take-off mechanism, wherein the planetary gear set includes a third member having an axial extension in driving connection with the power take-off mechanism.

10. The electric traction motor of claim 9, wherein the motor is positioned on the secondary axis, and wherein the power take-off mechanism is connected to the input member of the transmission and the primary axis via one of: a chain and sprockets and a consecutively-engaged sequence of two or more external gears.

11. The electric traction motor of claim 8, wherein:
the first member is a sun gear;
the reduction gear set further includes a third member configured as a carrier member with a plurality of pinion gears which mesh with the sun gear; and
the second member is a stationary ring gear which circumscribes the pinion gears and the sun gear.

12. The electric traction motor of claim 7, wherein the motor is characterized by an absence of a support bearing between the rotor and the reduction gear set.

13. A method for assembling an electric traction motor having a reduction gear set with a sun gear, a ring gear, and a carrier member with a plurality of pinion gears, the method comprising:
providing the reduction gear set, a stator with axially-extending end-windings defining a void or radial space with respect to each other, and a rotor, wherein the rotor circumscribes a rotor shaft to which the sun gear is connected or integrally formed;
connecting the ring gear to a stationary member such that the ring gear cannot rotate; and
inserting the carrier member into the ring gear from an axial side of the traction motor until the reduction gear set is positioned immediately adjacent to the rotor and substantially inside of the void or radial space between the axially-extending end windings.

14. The method of claim 13, wherein connecting the ring gear to the stationary member includes placing the ring gear immediately radially- and axially-adjacent to the end windings.

15. The method of claim 13, further comprising: connecting the rotor shaft to a transmission input member in a vehicle.

16. The method of claim 13, further comprising:
positioning the motor on a secondary axis of a vehicle; and
connecting an axial extension of the carrier member to a primary axis of the vehicle, wherein the primary axis is shared by an engine and a transmission of the vehicle.
